(19) United States
(12) Patent Application Publication
(10) Pub. No.: US 2005/0120793 A1
(43) Pub. Date: Jun. 9, 2005

(54) Tank fluid parameter monitoring device and method

(76) Inventors: Edward R. Cochran JR., Ridgeland, MS (US); Alton E. Windsor JR., Jackson, MS (US)

Correspondence Address: WILSON ENTERPRISES, 2333 BRIGHTON FARMS BLVD., KNOXVILLE, TN, 37932, US

(21) Appl. No.: 10/729,670

(22) Filed: Dec. 5, 2003

(51) Int. Cl. G01F 23/52

(52) U.S. Cl. 73/313

(57) ABSTRACT

The invention is a tank fluid parameter monitoring device with at least one tank having at least one tank fluid parameter, at least one tank fluid parameter sensor, and at least one smart transceiver in communication with at least one tank fluid parameter sensor. The smart transceiver further has a means for determining if at least one tank fluid parameter is within a predetermined range and a means for two-way transceiving at least one tank fluid parameter over wireless telemetry.

### FIELD OF THE INVENTION

The present invention generally relates to the measurement and monitoring of the liquid levels and pressures of products contained in bottles and tanks. The beverage dispensing and welding industries are typical users of such bottles and tanks. Both industries use CO₂ (carbon dioxide) while nitrogen, argon and helium are used in the welding industry. Both industries use insulated tanks to store and dispense the required gases and this invention functions generally the same for both industries. A primary use for this invention is to improve the economy and efficiency of bulk gas distributors. Information supplied by this invention improves maintenance and distribution activities and also improves operation cost effectiveness.

### BACKGROUND OF THE INVENTION

Tanks (also called bottles or vessels) that store liquid and dispense gas to different end users are common to many industries. These tanks are designed to deliver a specified flow of gas, for example, to carbonate a beverage or weld metals. The method and devices for determining tank liquid levels vary by tank manufacturer. Even the means for visually presenting the tank's liquid level on the exterior of the tank is unique to each manufacturer. Because of the diversity of measurement technologies between manufacturers and between different tank sizes, the devices and methods of measurement taught by this invention advance the art by adapting to each various technology. The ability to measure using the current float styles and being backwardly compatible to measure the older and antiquated measurement technologies is an advantage of this invention. Different measurement technologies spanning almost fifteen years required consideration of several data harvesting methods. The invention uses sensors that have been uniquely matched to these different float styles to accurately acquire and transmit tank fluid parameter data in an integrated device capable of continuous measurement.

Prior devices using Hall effect sensors measure tank level changes in multiple stepped increments by using multiple Hall switch sensors, not one linear sensor, and are mounted on the side of the float, perpendicular to the travel plane of the float, thereby providing tank level readings in ranges between fixed increments. With fixed incremental measurements, a true tank level measurement is not obtained and actual usage data over time is approximated using the incremental data. There is no full-scale continuous measurement of actual tank level for accurate reporting and control of fluid inventory.

### BRIEF SUMMARY OF THE INVENTION

The invention is a tank fluid parameter monitoring device and method with at least one tank having at least one tank fluid parameter, at least one tank fluid parameter sensor, and at least one smart transceiver in communication with at least one tank fluid parameter sensor. The smart transceiver further has a means for determining if at least one tank fluid parameter is within a predetermined range and a means for two-way transceiving at least one tank fluid parameter over wireless telemetry. The predetermined range is a tank specific parameter programmed into the smart transceiver indicative of the tank fluid level parameter or pressure parameter between approximately empty and full.

This invention continuously measures the amount of liquid present in a tank, and optionally measures pressures in a tank and in the service line feeding a dispensing system. The acquired data can be transmitted over wireless telemetry, via a paging or cellular network, using a smart transceiver having a radio frequency modem programmed to perform data acquisition and transceiving functions. The modem is connected to the wireless network enabling the invention to continuously and remotely communicate with an operator. There are no communication limitations as to when the operator and device can communicate. The modem is a two-way communication device meaning that either the device or the operator may initiate data transmission that flows unrestricted in both directions. Software controls the data acquisition and transceiving functions of the hardware. The sensors, the maintenance of all system variables, the analysis of all sensor information, the invention's diagnostics system, the invention's calibration process, and the data transmissions are some of the elements and functions of this invention. The invention commands and coordinates all the separate pieces of the hardware to function and perform together seamlessly.

### BRIEF DESCRIPTION OF THE DRAWINGS

FIG. 1 is a schematic of the direct float embodiment of the invention using one linear programmable Hall effect sensor positioned atop a float assembly.

FIG. 2 is a schematic of the indirect float embodiment of the invention using a potentiometer and a follower magnet assembly.

FIG. 3 is a schematic of the weight pad embodiment of the invention.

### DETAILED DESCRIPTION OF THE INVENTION

This invention relates to monitoring of liquid levels in tanks of approximately 100 to 1200 lb capacity range. The invention measures tank pressure, delivery pressure, and liquid levels. The invention is a telemetry product that communicates with a unique programmed set of instructions and a linear programmable Hall effect sensor or other sensor. The instructions perform data acquisition to determine the liquid level of the tank. The sensor(s) are programmed to a specified level of performance, for example sensitivity, to match the application. The invention also performs a calibration process in the on-board software to insure a maximum level of accuracy.

In one embodiment, liquid level sensing is done by at least one linear programmable Hall effect sensor capable of continuous readings showing a level change of less than 1% of full capacity range. Any sensor can be switched on and off for conserving power. The sensor communicates with on-board software that is custom designed for the device being measured. This method of measurement requires the hardware to be uniquely programmed and requires specially designed interpretation software to perform its function. The software, composed of over 9000 lines of unique instructions, controls the device and all action by the sensors, capturing and analyzing all data acquired, and performing all telecommunications functions via the wireless modem smart transceiver. The software can determine through error checking if sensed data is accurate. If accurate, the software checks the data for notification of an alarm status. If there is no need for an alarm to be sent, data is stored for later use. The smart transceiver is capable of two-way communication (both initiating outbound messages on its own and the receiving of inbound wireless communication) over the Reflex network or a cellular network. The Reflex network has coverage over a majority of the populated areas of North America and is the same network that supports all two-way paging devices.

The device is unique in the method and style of communication over a wireless network. The invention uses multiple combinations of modems and processor board arrangements for various embodiments of the smart transceiver, but the function of each device remains the same. This flexibility allows using the most cost effective radio frequency modem available at the time of installation. When data is received from the smart transceiver, it is stored in a database and posted on the Internet or other data display device. After the data has been received by the Internet website it can be transmitted via fax, phone (cellular or land), or pager.

The smart transceiver and sensor(s) are enclosed in a water resistant enclosure powered by either battery (DC) or AC power of various voltages. On board circuitry reduces the voltage to approximately 5 volts DC. The processor board distributes the power where it is needed and the software controls when power is activated. The software puts the smart transceiver, sensor, or both into a “sleep” mode that conserves power to extend the life of a battery, if a battery is used. The enclosure also houses the uniquely programmed linear programmable Hall effect sensor. For magnetic readings corresponding to tank levels, the device attaches to the magnetic housing on top of a tank. From a position on top of the float mechanism in the travel plane of the float magnet, the sensor detects the slightest movement of the float imposed by liquid level changes. Pressure transducers for sensing tank pressures can also be attached at the top of the tank in the gauge area. Data lines from the sensors connect to an analog-to-digital (A/D) port configured to sense and interpret sensor data. Pressure transducers used are typical for the industry and readily available.

Software acquires pressure and other tank fluid parameter readings, controls sensor functions, controls data transmission timing, controls device power for allowance of a “sleep” mode and battery operations, provides multiple diagnostic commands, accepts multiple sensor and measurement technologies, resides on multiple hardware platforms, and functions on a wide variety of tanks using expanded data tables for the measurement of tanks in the welding industry.

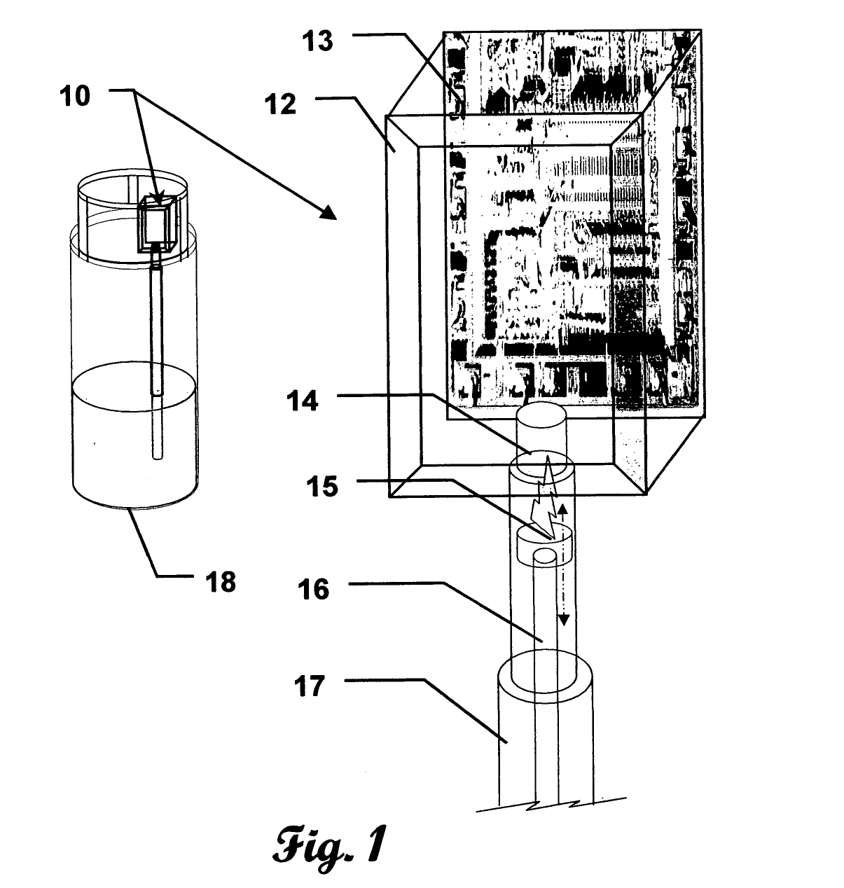

The invention uses different devices and methods of liquid level data acquisition depending on the tank hardware. An embodiment, as shown in FIG. 1, uses a linear programmable Hall effect sensor 14 that induces a voltage signal in ratiometric proportion to the proximate magnetic field created by the magnet 15 traveling in a casing 17. As the magnetic flux density at the sensor 14 changes proportional to its proximity of the magnet 15, or as the strength of the magnetic field changes, driven by the upward and downward movement of the magnet 15 on the float extension 16 that follows tank level changes, even as small as 1 gauss, the sensor 14 registers a change in voltage. The sensor 14 is programmed on a smart transceiver board 13 to a specified sensitivity that calibrates to a certain number of millivolts per gauss. The set quiescence voltage is approximately 0.5 volts. As the magnet 15 moves, voltage is added to the quiescence voltage from the sensitivity calculation performed during sensor calibration. By reading the voltage, and looking up its value in a programmed table, the liquid level inside the tank is determined. The smart transceiver and sensor are enclosed in a water resistant enclosure 12.

Other types of tank level measurement use Hall effect sensors as switch sensors positioned perpendicular to the direction of magnet travel. Switch sensors determine if the magnet position is proximate to the sensor and provide only on-off or two-position detection. Several sensors must be mounted in incremental segments for determination of tank level range. All sensors are measured simultaneously to determine which switch sensor set is activated. The current invention uses only one sensor 14 mounted on top of the float extension 16 essentially aligned in the direction of magnet travel. As the liquid level falls and the magnet 15 moves away from the sensor 14, the voltage falls in proportion to the fall in flux density. By taking a voltage reading and comparing it to a table stored in memory, the device determines the tank level. This embodiment uses one top mounted linear programmed sensor instead of several side mounted non-programmed switch sensors thereby providing a ratiometric continuous reading of tank level.

Pressures are measured by transducers that return voltage based upon forces. These voltages allow the on board application to calculate the current tank and line pressures. These devices are purchased and are manufactured to withstand the operating conditions.

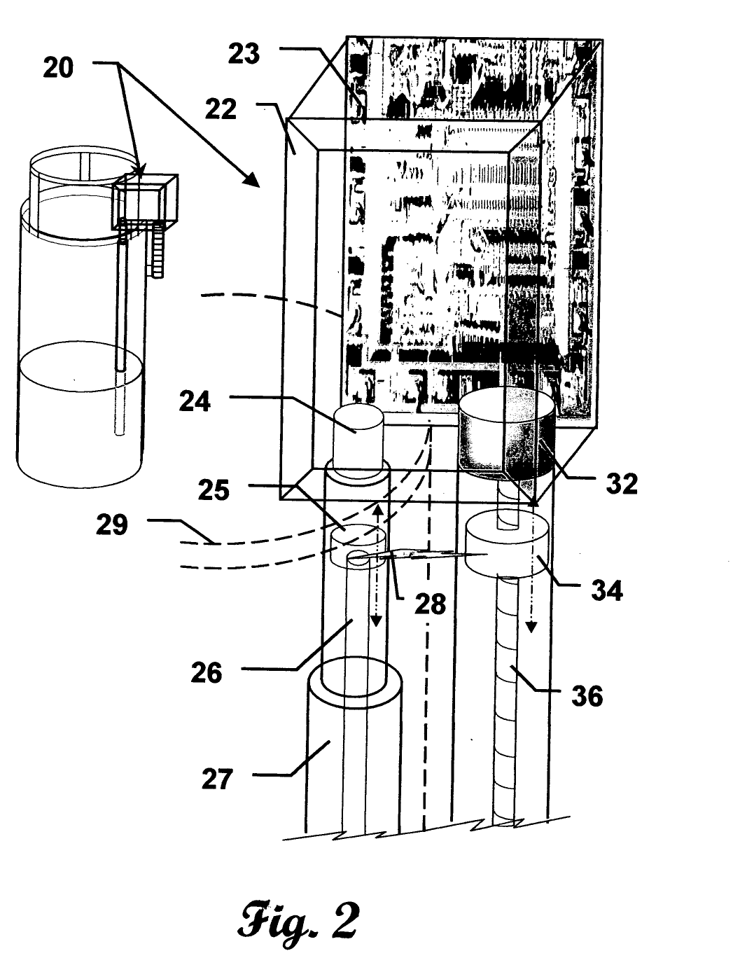

The invention will also encounter conditions that will require it to determine the liquid levels on more than one tank at a time. This task is accomplished by attaching more sensors to the appropriate ports on the smart transceiver board of the invention. The invention has been designed to monitor the liquid levels of one or more tanks at a time. The invention determines the liquid level of tanks using the current float technologies in the tanks by means of a specially developed sensor cap as shown in FIG. 2. This cap fits externally on the stem of the float device in the tank. This cap contains a follower magnet assembly 34 which travels up and down and magnetically 28 follows the magnet 25 in the tank's own float. This vertical movement is a constantly occurring cyclical process that happens as the tank is filled and emptied. The follower magnet assembly 34 rides on a spiral shaft 36 that is positioned parallel to the float stem 26 on the tank. The shaft 36 has a spiraling track fitted with a jeweled bearing assembly (not shown) on the lower end. The follower magnet assembly 34 has a corresponding and matching track that causes the shaft 36 to spin in the bearing as the follower magnet assembly 34 rises and falls. The position of the follower magnet assembly 34 on the spinning shaft is determined and reported by a low torque potentiometer 32 (which is connected to the upper end of the shaft) to the smart transceiver board 23. The controlling software can then determine the amount of liquid in the tank by the information it receives from the potentiometer 32 connected to the spinning shaft 36. The spiraled shaft 36, the follower magnet assembly 34 and sensor housing 22 have been specifically designed for this application. The rotational requirements for the most accurate readability of the device were calculated and matched with the low torque potentiometer 32 to achieve optimum functionality.

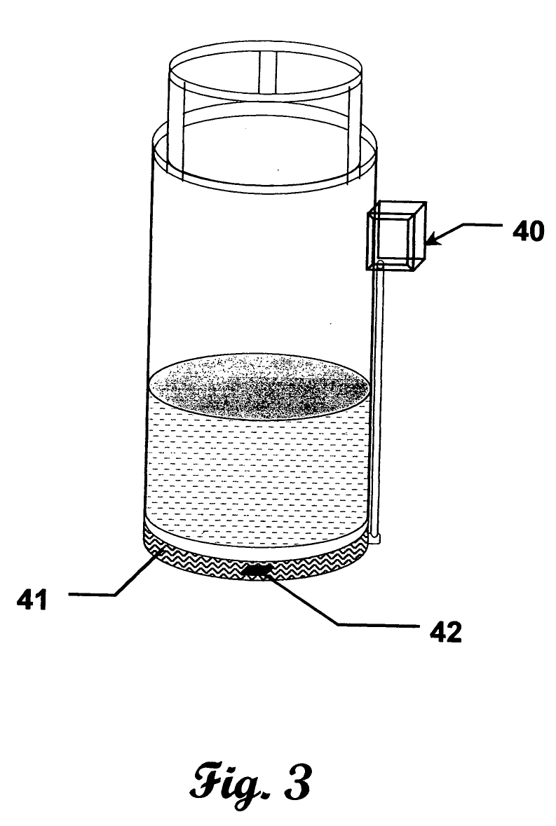

In another embodiment shown in FIG. 3, tanks that do not have readable float technologies require another method of data acquisition. Using waterproof pad(s) 41 having one or more capacitance sensors 42 mounted internally and a capacitance to voltage converter circuit, the invention measures the liquid level of any tank that is, for example, flat on the bottom. The pad 41, manufactured to specific size requirements, provides the smart transceiver 40 with a variable voltage output proportional to the weight of the tank. As the liquid in the tank is turned to gas and is dispensed, the total weight of the tank becomes less and thus the voltage falls proportional to the weight loss. The smart transceiver 40 controlling software calculates the tank level by subtracting the known tare weight of the empty tank from the measured total weight. Typical sensor and circuitry in the pad is manufactured by Loadstar Sensors. This embodiment also measures tank pressure and line pressure similar to other embodiments.

The invention provides a method for monitoring a tank fluid parameter by providing at least one tank having at least one tank fluid parameter, measuring at least one tank fluid parameter with a sensor, and transceiving the parameter using at least one smart transceiver in communication with at least one tank fluid parameter sensor. The smart transceiver further has a means for determining if at least one tank fluid parameter is within a predetermined range and a means for two-way transceiving the at least one tank fluid parameter over wireless telemetry. The predetermined range is a tank specific parameter programmed into the smart transceiver indicative of the tank fluid level parameter or pressure level between approximately empty and full.

The method by which the invention transmits wirelessly on a network that covers over 93% of the population of the continental U.S. is unique. The invention communicates without restriction on a two-way basis. Other communication methods use the land based telephone systems (not to be confused with a cellular network). This is very limiting due to the fact that the land-based systems must initiate the transmission and can only communicate when the telephone line is not in use. Smartsync and Advantra manufacture typical two-way radio frequency smart transceiver modems used in the invention. These devices provide only the modem hardware for the data collection and transmission. On board software, provided by this invention, directs and controls the sensors, processor board ports and transmission activities for remote determination of tank fluid parameters. The wireless modems transmit between approximately 896 and 902 MHz. The data transmission rate of the modem is between approximately 800 and 9600 bps depending on the Network provider. The modems have a RF power output range of approximately 0.05 and 2.0 watts. Reception of the modems occurs at frequencies between approximately 929 and 942 MHz at rates of between approximately 1600 and 6400 bps depending on the Network provider. The modems are continuously communicating with the Reflex network technology developed and licensed by Motorola. This Reflex technology is recognized as the standard in the U.S. and is used by all major Network providers in North America.

The current invention has been shown and described herein in what is considered to be the most practical and preferred embodiments. It is recognized, however, that departures may be made therefrom within the scope of the invention and that obvious modifications will occur to a person skilled in the art.

1. A tank fluid parameter monitoring device comprising;
at least one tank having at least one tank fluid parameter,
at least one tank fluid parameter sensor, said tank fluid parameter sensor further comprising one linear hall effect sensor in magnetic communication with a magnet, said hall effect sensor aligned essentially in the upward and downward travel plane of said magnet, said magnet disposed proportional to said tank fluid parameter, said hall effect sensor inducing a voltage signal in ratiometric proportion to the proximate magnetic field created by said magnet traveling in said upward and downward travel plane,
at least one smart transceiver in communication with at least one said tank fluid parameter sensor,
wherein said smart transceiver further comprises a means for determining if said at least one tank fluid parameter is within a predetermined range and a means for two-way transceiving said at least one tank fluid parameter over wireless telemetry.

2. The device of claim 1 wherein said tank fluid parameter is liquid level.

3. (canceled)

4. The device of claim 2 wherein said at least one tank fluid parameter sensor further comprises;
a potentiometer,
a float magnet disposed proportional to the liquid level tank fluid parameter,
a follower magnet assembly disposed in relation to said float magnet,
wherein said potentiometer is in mechanical communication with said follower magnet assembly and said follower magnet assembly is in magnetic communication with said float magnet

5. The device of claim 2 wherein said tank fluid parameter sensor further comprises;
a pad for sensing the weight of said tank,
a capacitance sensor disposed in said pad, and
a capacitance to voltage conversion circuit.

6. (canceled)

7. The device of claim 4 wherein said tank fluid parameter sensor further comprises a pressure transducer.

8. (canceled)

9. The device of claim 1 wherein said wireless telemetry further comprises a paging network.

10. The device of claim 1 wherein said wireless telemetry further comprises a cellular network.

11. A method for monitoring a tank fluid parameter comprising;
providing at least one tank having at least one tank fluid parameter,
measuring at least one tank fluid parameter with a tank fluid parameter sensor, said tank fluid parameter sensor further comprising one linear hall effect sensor in magnetic communication with a magnet, said hall effect sensor aligned essentially in the upward and downward travel plane of said magnet, said magnet disposed proportional to said tank fluid parameter, said hall effect sensor inducing a voltage signal in ratiometric proportion to the proximate magnetic field created by said magnet traveling in said upward and downward travel plane, and
transceiving said tank fluid parameter using at least one smart transceiver in communication with at least one said tank fluid parameter sensor, wherein said smart transceiver further comprises a means for determining if said at least one tank fluid parameter is within a predetermined range and a means for two-way transceiving said at least one tank fluid parameter over wireless telemetry.

12. The method of claim 11 wherein said tank fluid parameter is liquid level.

13. (canceled)

14. The method of claim 12 wherein said at least one tank fluid parameter sensor further comprises;
a potentiometer,
a float magnet disposed proportional to the liquid level tank fluid parameter,
a follower magnet assembly disposed in relation to said float magnet,
wherein said potentiometer is in mechanical communication with said follower magnet assembly and said follower magnet assembly is in magnetic communication with said float magnet.

15. The method of claim 12 wherein said tank fluid parameter sensor further comprises;
a pad for sensing the weight of said tank,
a capacitance sensor disposed in said pad, and
a capacitance to voltage conversion circuit.

16. (canceled)

17. The method of claim 14 wherein said tank fluid parameter sensor further comprises a pressure transducer.

18. The method of claim 15 wherein said tank fluid parameter sensor further comprises a pressure transducer.

19. The method of claim 11 wherein said wireless telemetry further comprises a paging network.

20. The method of claim 11 wherein said wireless telemetry further comprises a cellular network.
